(19) United States
(12) Patent Application Publication
(10) Pub. No.: US 2013/0059630 A1
(43) Pub. Date: Mar. 7, 2013

(54) MOBILE TERMINAL

(71) Applicant: Takahiro Naruse, Kanagawa (JP)

(72) Inventor: Takahiro Naruse, Kanagawa (JP)

(73) Assignee: PANASONIC CORPORATION, Osaka (JP)

(21) Appl. No.: 13/698,221

(22) PCT Filed: Jan. 18, 2012
(86) PCT No.: PCT/JP2012/000266

§ 371 Date: Nov. 15, 2012

(30) Foreign Application Priority Data
Mar. 15, 2011 (JP) 2011-056666

(51) Int. Cl. H04W 88/02

(52) U.S. Cl. 455/575.1

(57) ABSTRACT

A mobile terminal includes a first board, a first housing, and an elastic member. The elastic member includes a base having a first surface on which a support that can support the first board in a direction of an arrow is disposed, a claw that extends from the first surface of the base in the direction of the arrow, and holds the first board between the support and the claw, and extension portions that extend from the support of the base in the direction of the arrow, and are disposed on both sides of the claw.

### TECHNICAL FIELD

The present invention relates to a mobile terminal that includes a fixing member for a board inside a housing, and engages the fixing member with the board so as to fix the board to an interior of the housing.

### BACKGROUND ART

As a unit for fixing the board to the housing, there has been known a fixing unit in which a cantilever spring is integrated with a peripheral wall of the housing, and a claw is formed on a tip of the cantilever spring.

According to the fixing unit, the claw is abutted against the board to elastically deform the cantilever spring when the board that is a rigid body is arranged inside the housing.

After the board climbs over the claw while the cantilever spring is elastically deformed, the cantilever spring is restored to an original position. When the cantilever spring is restored, the claw is arranged at a position where the claw fixes the board so that the board can be fixed by the claw (for example, refer to Patent Literature 1).

### CITATION LIST

### Patent Literature

Patent Literature 1: JP-A-4-119208 (operation, FIG. 1)

### SUMMARY OF INVENTION

### Technical Problem

However, in the fixing unit of Patent Literature 1, the cantilever spring is integrated with the peripheral wall of the housing, and the claw is formed on the tip of the cantilever spring, and the claw is formed on the tip of the cantilever spring.

For that reason, in the fixing unit of Patent Literature 1, if the housing has no elasticity, since the cantilever spring cannot be integrated with the peripheral wall of the housing, it is difficult to fix the board to the interior of the housing.

The present invention has been made to solve the above-mentioned problem, and an object of the present invention is to provide a mobile terminal that fixes the board to the interior of the housing through an elastic member having a claw that holds the board.

### Solution to Problem

A mobile terminal according to an aspect of the invention includes: a first board; a housing; and an elastic member that includes a base having a first surface on which a support which can support the first board is disposed in a thickness direction of the housing, a claw that extends from the first surface of the base in the thickness direction of the housing, and holds the first board between the support and the claw in the thickness direction of the housing, and extension portions that extend from the support of the base in the thickness direction of the housing, and are disposed on both sides of the claw.

The housing is provided with the elastic member, and the elastic member is provided with the base and the claw. The first board is held between the support of the base and the claw.

With the above configuration, even if the housing is formed of a member having no elasticity, the board can be fixed to the interior of the housing through the elastic member having the claw that holds the first board.

The mobile terminal according to an aspect of the invention is also configured so that the housing includes a side wall having a concave portion, an elastically deformable rib is formed on a second surface of the base of the elastic member substantially perpendicular to the first surface, and the rib is elastically deformed to press-fit a part of the elastic member into the concave portion of the side wall of the housing so that the elastic member is fixed to the housing.

The elastic member is provided with a rib. The rib is elastically deformed so that the elastic member can be press-fitted into the concave portion of the side wall of the housing so as to be fixed to the housing.

As a result, the elastic member that fixes the first board can be easily fitted to the housing by merely elastically deforming the rib.

The mobile terminal according to an aspect of the invention is also configured so that the mobile terminal includes a second board that includes a notch and is different from the first board, and the base of the elastic member includes a concave portion that is protruded from a third surface facing the first surface in the thickness direction of the housing to be engaged with the notch of the second board.

The third surface is formed on the base of the elastic member, and the convex portion is formed on the third surface. The convex portion is engaged with the notch of the second board.

Thus, the notch of the second board is engaged with the convex portion so that the rotation of the second board can be controlled by the convex portion.

The mobile terminal according to an aspect of the invention is also configured so that the second board having the notch engaged with the convex portion of the elastic member is held between the third surface of the base of the elastic member and the side wall of the housing in the thickness direction of the housing.

The notch of the second board is engaged with the convex portion of the elastic member so that the second board can be held between the third surface of the elastic member and the side wall of the housing.

Thus, since the second board is held between the third surface and the side wall so that the second board can be fixed to the interior of the housing.

The mobile terminal according to an aspect of the invention is also configured so that rigidities of the first board, the second board, and the housing are higher than a rigidity of the elastic member.

The rigidity of the housing is set to be higher than the rigidity of the elastic member so that the elastic member can be surely fixed to the housing.

Further, the rigidities of the first board and the second board are set to be higher than the rigidity of the elastic member so that the first board and the second board can be prevented from being deformed in a state where the first board and the second board are abutted against the elastic member.

As a result, the first board and the second board can be further surely fixed to the interior of the housing through the elastic member.

### Advantageous Effects of Invention

According to the mobile terminal of the present invention, the housing is equipped with the elastic member, and the first board is held between the support and the claw of the elastic member.

As a result, even if the housing is formed of the member having no elasticity, the board can be fixed to the interior of the housing through the elastic member having the claw that holds the board.

### BRIEF DESCRIPTION OF DRAWINGS

FIG. 1 is a perspective view illustrating a state in which a mobile terminal is in a usable state (open state) according to an aspect of the present invention.

FIG. 2 is an exploded perspective view illustrating the mobile terminal in FIG. 1.

FIG. 3 is a perspective view illustrating a state where a first base and a second base are received in a first housing in FIG. 1.

FIG. 4 is a perspective view illustrating a state where an elastic member of FIG. 2 is viewed from a front surface side.

FIG. 5 is a perspective view illustrating a state where the elastic member of FIG. 2 is viewed from a rear surface side.

FIG. 6 is a cross-sectional view taken along a line I-I in FIG. 3.

FIG. 7 is a cross-sectional view taken along a line II-II in FIG. 3.

FIG. 8 is a perspective view illustrating a procedure of assembling an elastic member and a first board into a first housing according to the aspect of the present invention.

FIG. 9 is a perspective view illustrating a state where the elastic member and the first board are assembled into the first housing according to the aspect of the present invention.

FIG. 10 is a perspective view illustrating a procedure of assembling the first board into the first housing according to the aspect of the present invention.

FIG. 11 is a perspective view illustrating a state where the first board and the second board are assembled into the first housing according to the present invention.

### MODES FOR CARRYING OUT INVENTION

Hereinafter, a mobile terminal according to an embodiment of the present invention will be described with reference to the drawings.

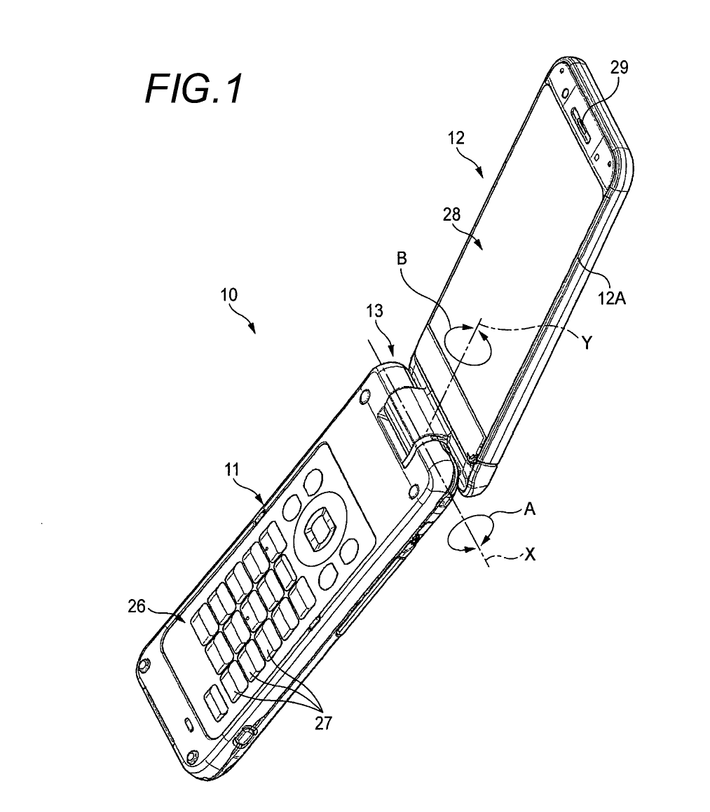

As illustrated in FIG. 1, a mobile terminal 10 according to the embodiment of the present invention represents a cellular phone in which a first housing (housing) 11 and a second housing 12 are coupled with each other through a hinge portion 13 so as to be relatively movable.

The hinge portion 13 is configured to couple the first housing 11 and the second housing 12 with each other so as to be rotatable about a first rotation axis X in a direction of an arrow A between a usable state (open state) and a portable state (closed state).

Further, the hinge portion 13 is configured to be coupled with the second housing 12 so as to be rotatable about a second rotation axis Y in a direction of an arrow B.

That is, the mobile terminal 10 represents a mobile terminal of a swivel type having two axes of the first rotation axis X and the second rotation axis Y.

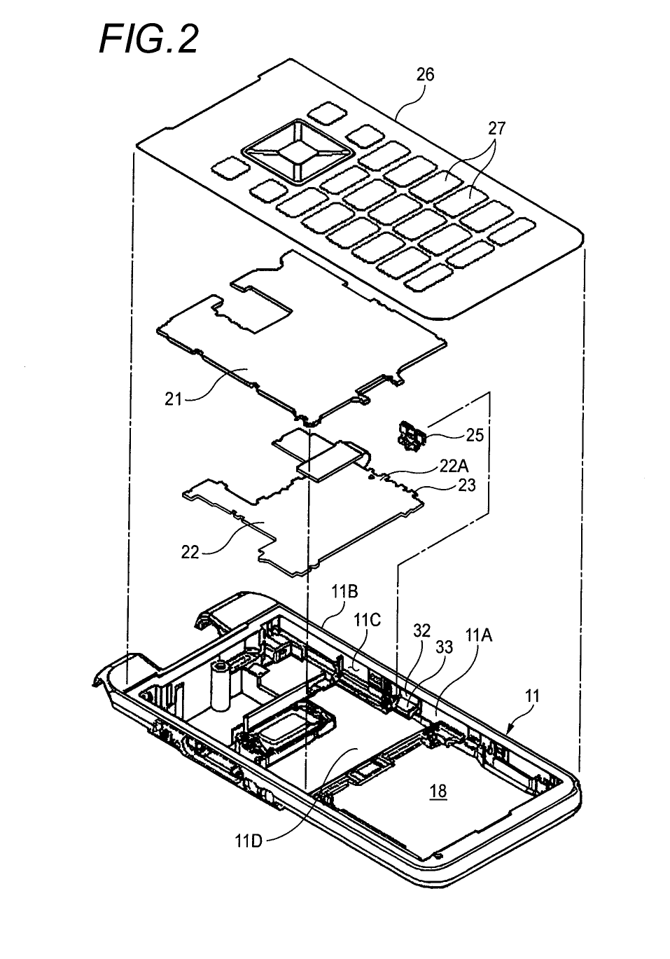

Further, as illustrated in FIG. 2, the mobile terminal 10 includes a first board 21 and a second board 22 disposed in an interior 18 of the first housing 11, an elastic member 25 that fixes the first board 21 and the second board 22 with each other, and a key sheet 26 having multiple keys 27.

As illustrated in FIG. 1, the second housing 12 is equipped with a display portion 28 and a receiver 29 on a front surface 12A thereof.

The receiver 29 represents a device having a diaphragm (not shown), which generates, for example, a voice received during a call.

As illustrated in FIG. 2, the first housing 11 is formed into a substantially rectangular box having a side wall 11A, and an upper opening portion 11B is covered with the key sheet 26. The first housing 11 is formed of a member higher in rigidity than the elastic member 25.

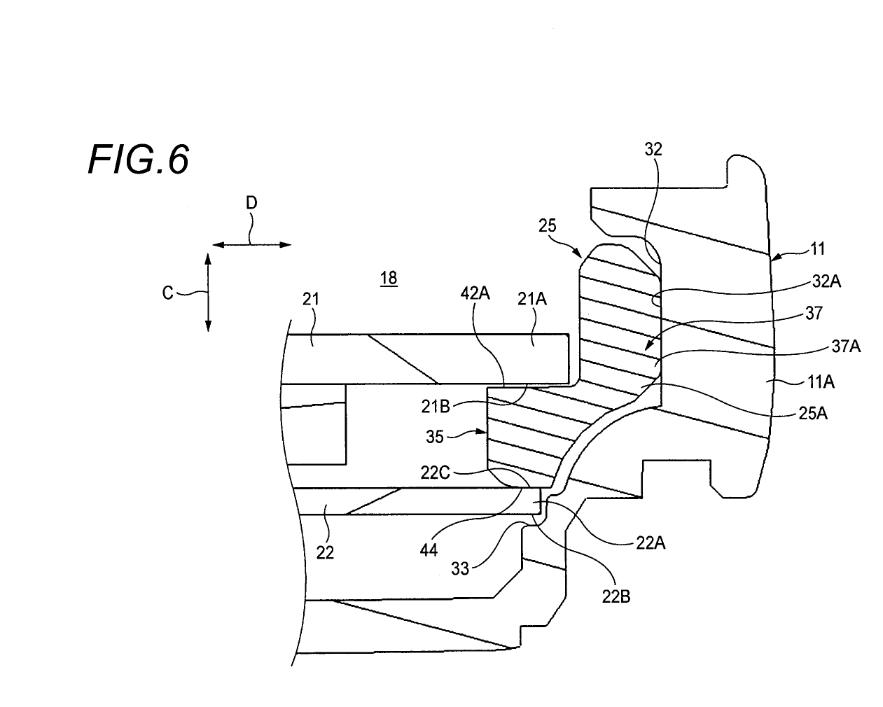

The side wall 11A includes a concave portion 32 formed in an inner surface 11C of the side wall 11A, and a lower end 33 (also refer to FIG. 6) disposed in the inner surface 11C.

The concave portion 32 is configured to be recessed in the inner surface 11C of the side wall 11A so as to receive the elastic member 25 therein.

The lower end 33 is configured to be protruded toward the interior 18 of the first housing 11 from the inner surface 11C so as to support an end 22A of the second board 22.

The first board 21 is formed into a substantially rectangular shape so as to be received in the interior 18 of the first housing 11, and formed of a member higher in rigidity than the elastic member 25.

The second board 22 is different from the first board 21, and formed into a substantially rectangular shape so as to be received in the interior 18 of the first housing 11.

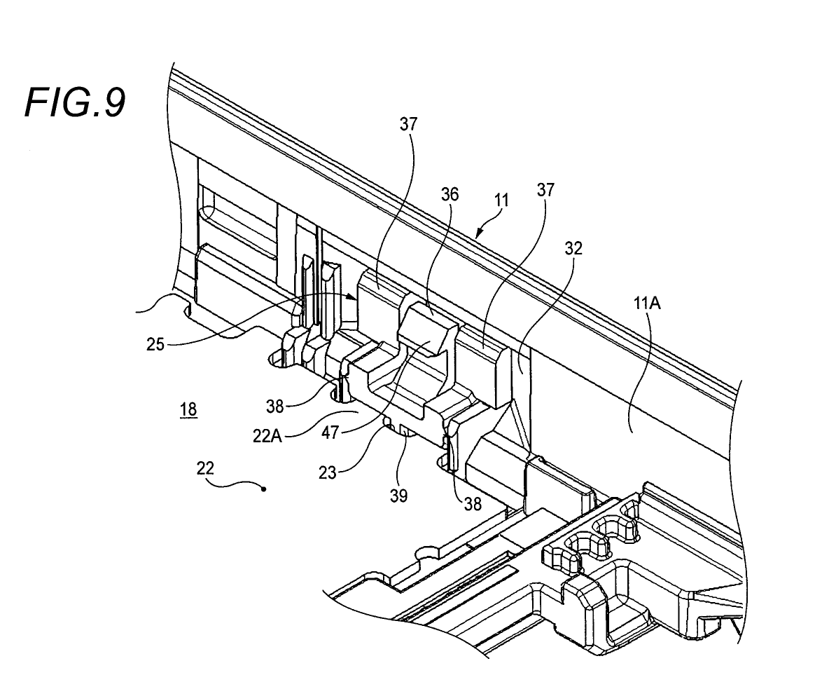

The second board 22 has a notch 23 (also refer to FIG. 9) that can be engaged with the elastic member 25, and formed of a member higher in rigidity than the elastic member 25.

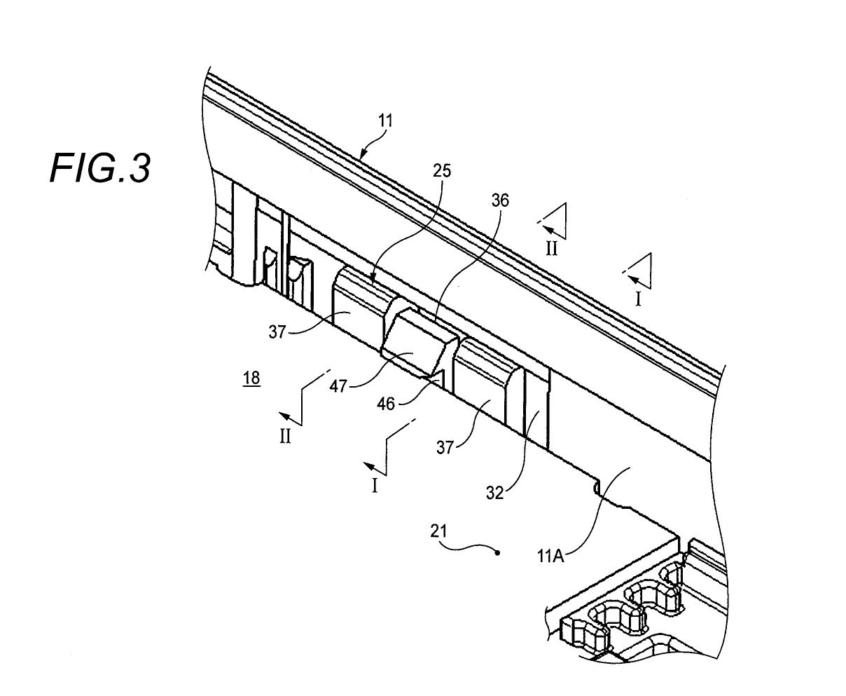

As illustrated in FIG. 3, the elastic member 25 represents a fixing member that can be received in the concave portion 32 formed into the side wall 11A of the first housing 11, and enables the first board 21 and the second board 22 (also refer to FIG. 2) to be fixed to the interior 18 of the first housing 11.

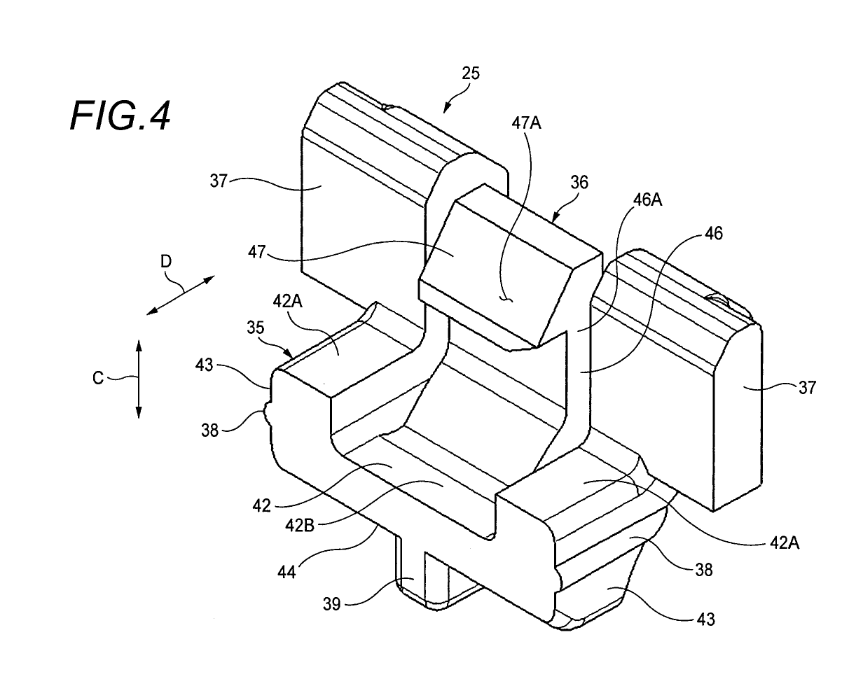

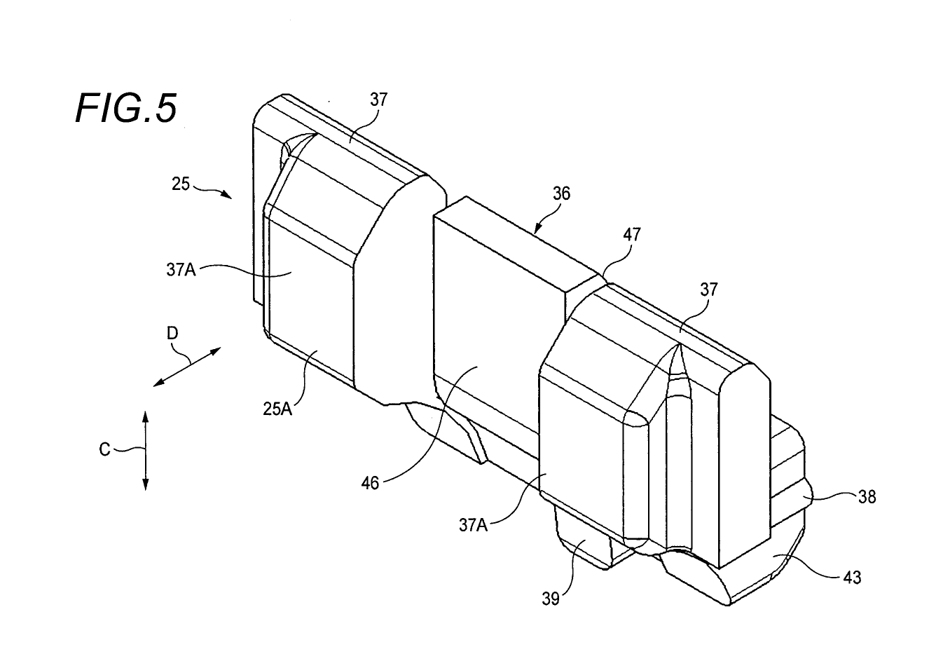

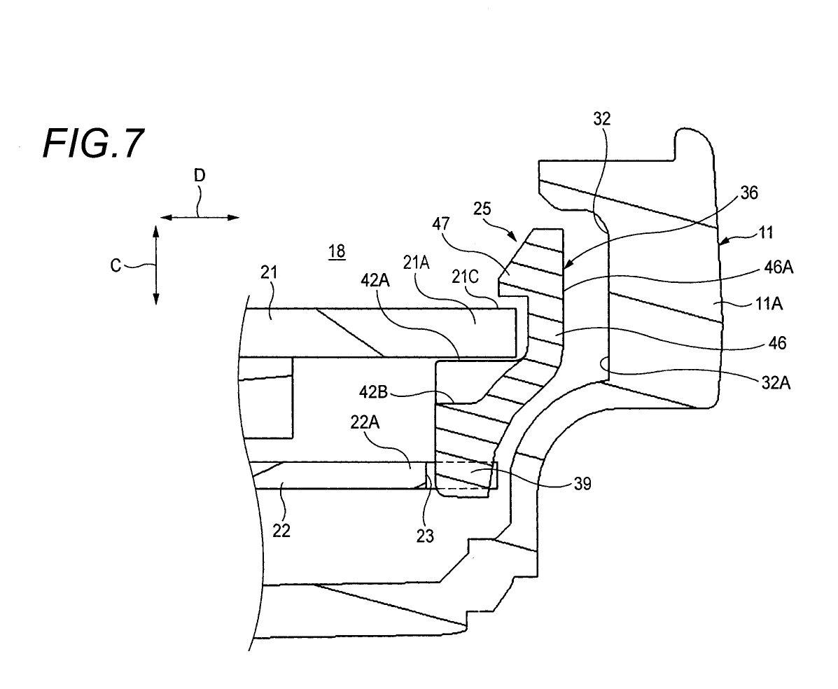

As illustrated in FIGS. 4 and 5, the elastic member 25 includes a base 35 that can support the first board 21 (refer to FIG. 6), a claw 36 that holds the first board 21 between the base 35 and the claw 36, a pair of extension portions 37 disposed on both sides of the claw 36, a pair of ribs 38 disposed on the base 35, and a concave portion 39 that is engaged with the second board 22 (refer to FIG. 7).

The base 35 is formed into a substantially rectangular shape, and includes a first surface 42 disposed on an upper portion thereof, a pair of second surfaces 43 disposed on both sides thereof, and a third surface 44 disposed on a lower portion thereof.

The first surface 42 is disposed on the upper portion of the base 35, and a pair of supports 42A is disposed on both ends thereof.

The pair of supports 42A is raised above and can support an end 21A of the first board 21 in a thickness direction of the first housing 11 (direction of an arrow C) (refer to FIG. 6).

The pair of second surfaces 43 is disposed on both sides of the base 35 in a direction substantially perpendicular to the first surface 42.

The third surface 44 is disposed on the lower portion of the base 35 so as to face the first surface 42.

The claw 36 includes a claw elastic portion 46 extended toward the thickness direction (direction of the arrow C) of the first housing 11 from a region between the pair of supports 42A of the base 35, and an engagement claw 47 protruded from an upper end 46A of the claw elastic portion 46 in a width direction (direction of an arrow D) of the first housing 11.

The claw elastic portion 46 is extended in the thickness direction (direction of the arrow C) of the first housing 11 from an intermediate region 42B between the pair of supports 42A, in the first surface 42 of the base 35.

The claw elastic portion 46 is formed to be elastically deformable in the width direction (direction of the arrow D) of the first housing 11 with the upper end 46A as a free end.

The engagement claw 47 is protruded in the width direction (direction of the arrow D) of the first housing 11 so as to be arranged above the pair of supports 42A at a given distance (specifically, a distance of a thickness dimension of the end 21A of the first board 21).

As illustrated in FIG. 7, the engagement claw 47 can hold the end 21A of the first board 21 between the engagement claw 47 and the pair of supports 42A in the thickness direction (direction of the arrow C) of the first housing 11.

The extension portions 37 extend from the pair of supports 42A in the thickness direction (direction of the arrow C) of the first housing 11 so as to be disposed on both sides of the claw 36.

The extension portions 37 are configured so that rear portions 37A are swelled backward from the claw 36.

The rear portions 37A of the extension portions 37 swelled backward so that the rear portions 37A contact with a bottom surface 32A of the concave portion 32 in a state where the elastic member 25 is received in the concave portion 32 as illustrated in FIG. 6.

In this state, as illustrated in FIG. 7, the claw 36 is distant from the bottom surface 32A of the concave portion 32. Hence, in the state where the elastic member 25 is received in the concave portion 32, the claw 36 can be elastically deformed in a direction of moving away from the first board 21.

The pair of ribs 38 includes one rib 38 elastically deformable which is protruded outward from one second surface 43, and the other rib 38 elastically deformable which is protruded outward from the other second surface 43.

The one rib 38 is extended on one second surface 43 toward the width direction (direction of the arrow D) of the first housing 11.

The other rib 38 is extended on the other second surface 43 toward the width direction (direction of the arrow D) of the first housing 11.

The pair of ribs 38 is elastically deformed so that a part 25A of the elastic member 25 is fitted into the concave portion 32 of the first housing 11, and the elastic member 25 is fixed to the side wall 11A of the first housing 11, as illustrated in FIG. 3.

As illustrated in FIG. 7, the concave portion 39 is disposed below the base 35 on the third surface 44 facing the first surface 42.

The concave portion 39 is protruded from the third surface 44 in the thickness direction (direction of the arrow C) of the first housing 11 so as to be engaged with the notch 23 of the second board 22.

As illustrated in FIG. 6, in a state where the second board 22 is received in the interior 18 of the first housing 11, a lower surface 22B of the end 22A of the second board 22 is supported by the lower end 33 of the side wall 11A.

Further, an upper surface 22C of the end 22A of the second board 22 is held by the third surface 44.

That is, the end 22A of the second board 22 is held between the third surface 44 and the lower end 33 of the side wall 11A of the first housing 11 in the thickness direction (direction of the arrow C) of the first housing 11.

Thus, the end 22A of the second board 22 is held between the third surface 44 and the lower end 33 of the side wall 11A so as to fix the second board 22 to the interior 18 of the first housing 11.

As illustrated in FIG. 7, in a state where the end 22A of the second board 22 is held between the third surface 44 and the lower end 33 (refer to FIG. 6) of the side wall 11A, the notch 23 of the second board 22 is engaged with the concave portion 39 of the elastic member 25 (refer to FIG. 9).

Thus, the concave portion 39 is engaged with the notch 23 of the second board 22 so that the rotation of the second board 22 can be controlled by the convex portion 39.

As illustrated in FIG. 6, in a state where the first board 21 is received in the interior 18 of the first housing 11, a lower surface 21B of the end 21A of the first board 21 is supported by the pair of supports 42A.

As illustrated in FIG. 7, in a state where the first board 21 is received in the interior 18 of the first housing 11, an upper surface 21C of the end 21A of the first board 21 is held by the engagement claw 47.

That is, the first board 21 is fixed to the interior 18 of the first housing 11 by holding the end 21A between the engagement claw 47 and the pair of supports 42A.

Thus, the first housing 11 is provided with the elastic member 25, and the elastic member 25 is provided with the base 35 and the claw 36. Further, the first board 21 is held between the supports 42A provided in the base 35 and the claw 36.

With the above configuration, even if the first housing 11 is formed of a member having no elasticity, the elastic member 25 is fixed to the concave portion 32 of the first housing 11 so that the first board 21 can be fixed to the interior 18 of the first housing 11 through the elastic member 25.

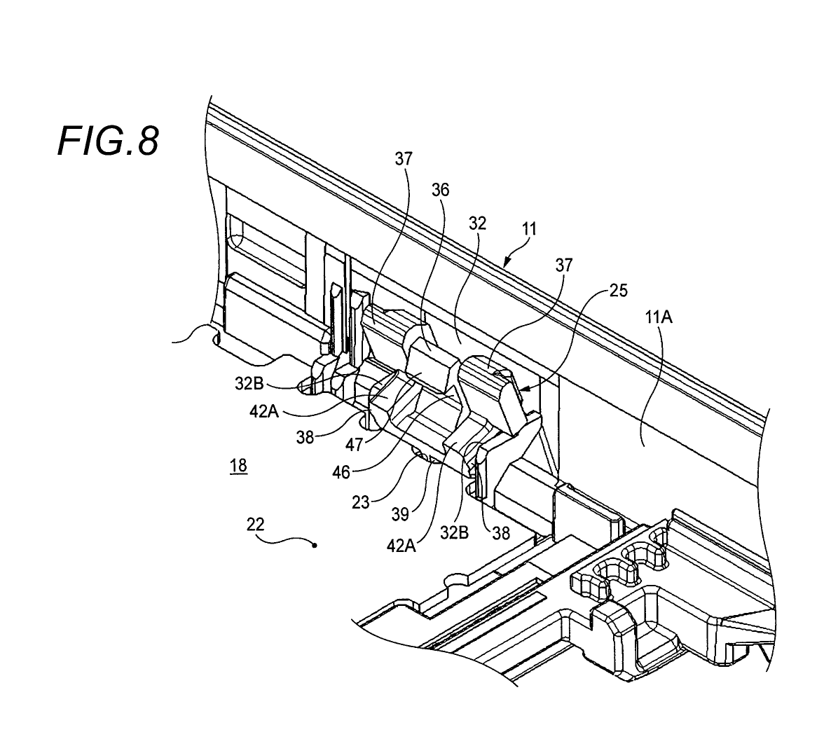

Subsequently, A process of assembling the first board 21 and the second board 22 in the interior 18 of the first housing 11 will be described with reference to FIGS. 8 to 11.

As illustrated in FIG. 8, the elastic member 25 is inclined toward a bottom 11D (refer to FIG. 2) of the first housing 11, and the notch 23 of the second board 22 is engaged with the concave portion 39 of the elastic member 25 in an inclined state.

The elastic member 25 is press-fitted into the concave portion 32 in the state where the notch 23 is engaged with the concave portion 39 whereby the pair of ribs 38 of the elastic member 25 is abutted against both walls 32B of the concave portion 32 so as to be elastically deformed.

As illustrated in FIG. 9, the pair of ribs 38 is elastically deformed so that the part 25A (refer to FIG. 6) of the elastic member 25 is fitted into the concave portion 32 of the side wall 11A of the first housing 11, and the elastic member 25 is fixed to the first housing 11.

Thus, the elastic member 25 that fixes the first board 21 can be easily fitted to the first housing 11 by merely elastically deforming the pair of ribs 38.

In this example, the rigidity of the first housing 11 is set to be higher than the rigidity of the elastic member 25. Hence, the elastic member 25 is surely fixed to the first housing 11.

In this state, the notch 23 of the second board 22 is engaged with the concave portion 39 of the elastic member 25. At the same time, as illustrated in FIG. 6, the second board 22 is held between the third surface 44 of the elastic member 25 and the lower end 33 of the side wall 11A.

Thus, the second board 22 is held between the third surface 44 and the lower end 33 of the side wall 11A so that the second board 22 can be fixed to the interior 18 of the first housing 11.

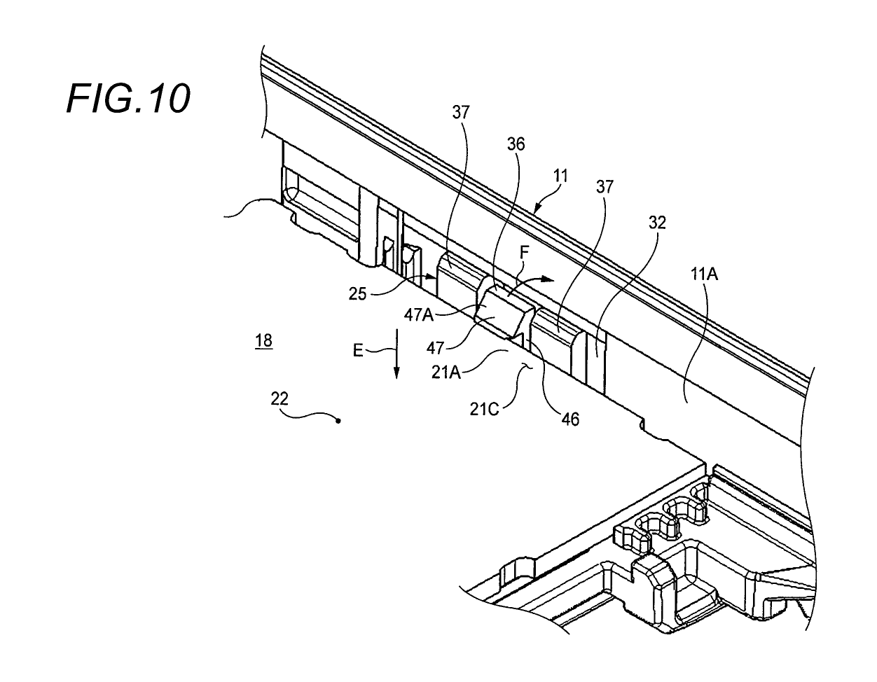

As illustrated in FIG. 10, the first board 21 is pressed down toward the interior 18 of the first housing 11 as indicated by an arrow E. The end 21A of the first board 21 is abutted against an inclined surface 47A of the engagement claw 47, and the engagement claw 47 is pressed in a direction of an arrow F.

The engagement claw 47 is pressed by the end 21A of the first board 21 in the direction of the arrow F to elastically deform the claw elastic portion 46, and the engagement claw 47 is guided in a direction of moving away from the end 21A of the first board 21.

The engagement claw 47 is guided in a direction of moving away from the end so that the end 21A of the first board 21 can climb over the engagement claw 47.

When the end 21A of the first board 21 climbs over the engagement claw 47, the claw elastic portion 46 is restored to an original position.

When the claw elastic portion 46 is restored, the engagement claw 47 is arranged at a position where the engagement claw 47 fixes the end 21A of the first board 21. The upper surface 21C of the end 21A of the first board 21 is held by the engagement claw 47 (refer to FIG. 7).

As illustrated in FIG. 7, the end 21A of the first board 21 is held between the engagement claw 47 and the pair of supports 42A so that the first board 21 is fixed to the interior 18 of the first housing 11.

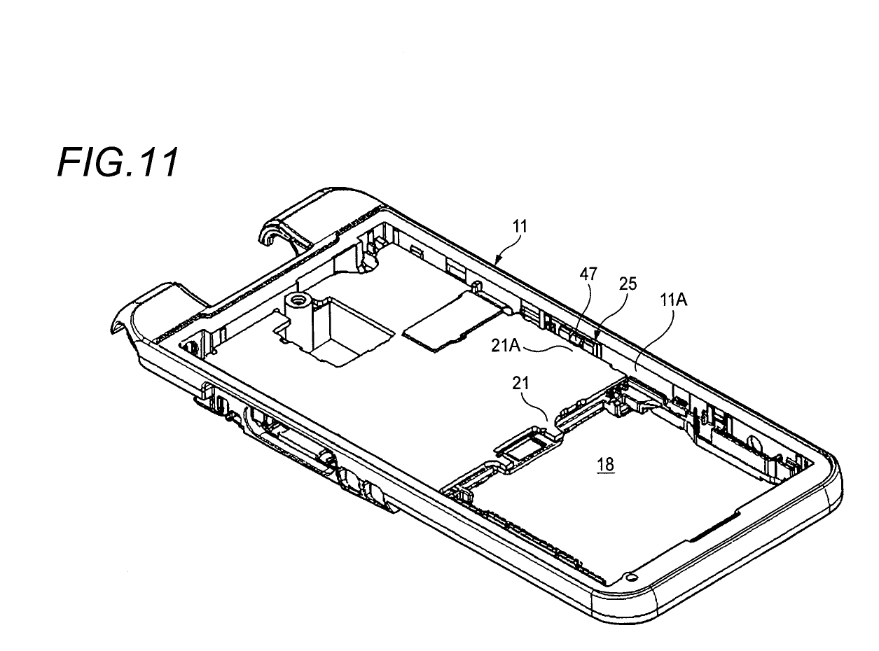

As illustrated in FIG. 11, the rigidity of the first housing 11 is set to be higher than the rigidity of the elastic member 25 so that the elastic member 25 is surely fixed to the first housing 11.

Further, the rigidities of the first board 21 and the second board 22 (refer to FIG. 9) are set to be higher than the rigidity of the elastic member 25. Hence, the first board 21 and the second board 22 can be prevented from being deformed in the state where the first board 21 and the second board 22 are abutted against the elastic member 25.

As a result, the first board 21 and the second board 22 can be further surely fixed to the interior 18 of the first housing 11 through the elastic member 25.

The mobile terminal according to the present invention is not limited to the above-mentioned embodiment, but can be appropriately modified and improved.

For example, in this embodiment, the mobile terminal 10 is exemplified as the cellular phone. However, the present invention is not limited to this configuration, but can be applied to other mobile terminals.

Also, the shapes and the configurations of the mobile terminal, the first housing, the first board, the second board, the notch, the elastic member, the concave portion, the base, the claw, the extension portions, the ribs, the convex portion, the first surface, the supports, the second surfaces, and the third surface used in the embodiment are not limited to those exemplified, but can be appropriately changed.

The present invention has been described in detail or with reference to the specific embodiment, however, it would be obvious to an ordinary skilled person that the present invention can be variously changed or modified without departing from the spirit and scope of the present invention.

The present invention is based on Japanese Patent Application No. 2011-056666 filed on Mar. 15, 2011, and content thereof is incorporated herein by reference.

### INDUSTRIAL APPLICABILITY

The present invention is suitable to the application to the mobile terminal having the fixing member that fixes the boards to the interior of the housing, in which the fixing member is elastically deformed, and the fixing member is engaged with the board to fix the boards to the interior of the housing.

### REFERENCE SIGNS LIST

10: mobile terminal
11: first housing (housing)
11A: side wall
21: first board
22: second board
23: notch
25: elastic member
25A: part of elastic member
32: concave portion
35: base
36: claw
37: extension portion
38: rib
39: concave portion
42: first surface
42A: support
43: second surface
44: third surface

1. A mobile terminal, comprising:
a first board;
a housing; and
an elastic member that includes
a base having a first surface on which a support which can support the first board is disposed in a thickness direction of the housing,
a claw that extends from the first surface of the base in the thickness direction of the housing, and holds the first board between the support and the claw in the thickness direction of the housing, and
extension portions that extend from the support of the base in the thickness direction of the housing, and are disposed on both sides of the claw, wherein
the housing includes a side wall having a concave portion,
an elastically deformable rib is formed on a second surface of the base of the elastic member substantially perpendicular to the first surface, and
the rib is elastically deformed to press-fit a part of the elastic member into the concave portion of the side wall of the housing so that the elastic member is fixed to the housing.

2. (canceled)

3. The mobile terminal according to claim 1, comprising
a second board that includes a notch and is different from the first board, wherein
the base of the elastic member includes a concave portion that is protruded from a third surface facing the first surface in the thickness direction of the housing to be engaged with the notch of the second board.

4. The mobile terminal according to claim 3, wherein
the second board having the notch engaged with the convex portion of the elastic member is held between the third surface of the base of the elastic member and the side wall of the housing in the thickness direction of the housing.

5. The mobile terminal according to claim 1, wherein
rigidities of the first board, the second board, and the housing are higher than a rigidity of the elastic member.
